(19) United States
(12) Patent Application Publication
(10) Pub. No.: US 2009/0047398 A1
(43) Pub. Date: Feb. 19, 2009

(54) Meat product and method for making same

(76) Inventors: Gary Uram, Omaha, NE (US); Erik Hassid, Omaha, NE (US)

Correspondence Address: SUITER SWANTZ PC LLO, 14301 FNB PARKWAY, SUITE 220, OMAHA, NE, 68154, US

(21) Appl. No.: 11/893,388

(22) Filed: Aug. 15, 2007

(51) Int. Cl. A23L 1/318; A23L 1/03; A23L 1/325; A23L 1/31

(52) U.S. Cl. 426/323; 426/332; 426/645

(57) ABSTRACT

The present application is directed to a meat product, including a cut cut of meat and a seasoning and cure solution. The cut of meat having muscle fibers oriented in a substantially uniform direction. The cut of meat being sliced across the grain of the muscle fibers and the seasoning and cure solution being applied to the cut of meat.

### BACKGROUND

Meat is a staple of many diets, has a unique flavor and can be very healthy. However, preserving meat and food products containing meat remains a challenge. Meat does not have a shelf life that allows for storages before microorganisms begin digesting the meat. Many of the microorganisms commonly found digesting meat can be harmful to humans. Thus finding ways to preserve meat is an old problem. Partially dehydrating meat products is a common way of preserving meat.

The problem with partially dehydrating meat is that the partially dehydrated meat can become tough, and difficult to chew. Further complicating the problem is that traditionally dehydrated meat products have been made from what is considered lower quality cuts of meat. Meat cuts are considered of lower quality if they have high amounts of connective tissue. Traditionally, lower quality meats which inherently are tougher are subjected to partially dehydration as a means to preserve the meat, making the already inherently tough meat, more tough.

Consequently what is needed is a method to preserve meat using a dehydration process that provides a more tender meat product to the consumer that is flavorful and easier to chew.

### SUMMARY

Accordingly, a meat product may include: a cut of meat having muscle fibers oriented in a substantially uniform direction; and a seasoning and cure solution; wherein the cut of meat is cut substantially across the grain of the muscle fibers and the seasoning and cure solution is applied to the cut of meat.

A method for making a meat product may include: offering a cut of meat having fibers oriented in a substantially uniform direction; slicing the meat substantially across the grain of the muscle fibers into a first portion; tenderizing the meat; applying a seasoning and cure solution to the meat; and cooking the meat.

It is to be understood that both the foregoing general description and the following detailed description are exemplary and explanatory only and are not necessarily restrictive of the meat product or method for making the meat product as claimed. The accompanying drawings, which are incorporated in and constitute a part of the specification, illustrate an example of the meat product and method for making the meat product and together with the general description, serve to explain the principles of the meat product and method for making the meat product.

### BRIEF DESCRIPTION OF THE DRAWINGS

The numerous advantages of the meat product and method for making the meat product may be better understood by those skilled in the art by reference to the accompanying figures in which:

FIG. 1 depicts the meat product, showing seasoning, and the orientation of the muscle fibers.

FIG. 2 depicts a whole muscle cut of meat having two portions where the muscle fibers of the two portions are oriented in different directions.

FIG. 3 depicts a cut of meat including the muscle fibers where the cut of meat is being sliced substantially across the grain of the muscle fibers.

FIG. 4 illustrates a method for making a meat product.

### DETAILED DESCRIPTION

Reference will now be made in detail to the meat product and method for making the meat product, examples of which are illustrated in the accompanying drawings.

Referring generally to FIGS. 1-4, a meat product 1 and a method for making a meat product 400 is described.

Referring now to FIG. 1, a meat, product 1 is shown. The meat product 1 may be made by starting with a whole muscle cut of beef 200, a cut of meat 300, or portions thereof. The meat product 1 may have muscle fibers 102 oriented in a substantially uniform direction, and the meat product may be sliced substantially across the grain of the muscle fibers 102. The meat product 1 may be injected with a seasoning and cure solution or coated with seasoning particulates 104.

The meat product 1 may be kippered for preservation. The definition of a kippered meat product is defined by the United States Department of Agriculture. A kippered meat product has specific analytical requirements as defined by the United States Department of agriculture, including having a fat content no greater than 15.8% by weight, a salt content no greater than 6.6% by weight, and a protein content no less than 28.2% by weight. The aerobic plate count of a kippered meat product cannot be greater than 75,000 colonies per gram in four of five samples, and not greater than 150,000 per gram in any one sample. The E. coli count shall be less than 3 per gram in four of five samples, and no greater than 10 colonies per gram in any one sample. The water activity may be no greater than 0.850 in a kippered product.

The meat product 1 may vary in the fat content, salt content, protein content and water activity provided that the meat product satisfies the requirements of a kippered meat product.

Alternatively, the meat product 1 may be preserved using other methods known in the art. The meat product 1 may be preserved by making jerky strips or jerky slices. A jerky meat product has specific analytical requirements including a fat content less than or equal to 30.0% by mass of the meat product, a salt content less than or equal to 5.0% by mass of the meat product, and a protein content greater than or equal to 25.0% by mass of the meat product.

The meat product 1 may be tenderized to break down the muscle fibers yielding a more tender meat product 1. Muscle fibers are generally comprised of two types of tissue, collagen and elastin. By breaking up the collagen and elastin, the meat product 1 may have a more tender texture than a meat product 1 which has not been tenderized. The meat product 1 may be tenderized using any method known in the art to tenderize meat. The meat product 1 may be tenderized with a blade tenderizer. The meat product 1 may be tenderized using a blade hammer. Alternatively, the meat product 1 may be tenderized using both a blade tenderizer and a blade hammer.

The meat product 1 may be cured. Meat curing may be the application of salt, color fixing ingredients and seasoning in order to impart unique properties to the meat product. Meat products are highly perishable in which deterioration begins soon after bleeding the animal. The primary cause of product deterioration is microorganisms such as bacteria and fungi. Cured meat products are frequently prepared to preserve the meat product for use at some future time. Rapid chilling of a meat product is one of the best ways to keep meat product deterioration to a minimum. A meat product which has not been chilled may begin spoiling before the cure solution penetrates to the center of the meat product.

Meat curing materials may contain salt, nitrite and nitrate. However, other substances can be added to the curing material to accelerate curing, stabilize color, modify flavor and reduce shrinkage during processing. Salt is traditionally one of the primary ingredients used in meat curing. Salt may serve as a preservative by dehydrating the meat product and altering the osmotic pressure of the meat product to inhibit bacterial growth. Salt also serves to add flavor to a cured meat product. The salt level found in a meat product may varying depending on the consumer preference and necessary levels to assist in preserving the meat. However, a salt level concentration of about 2-3% in the meat product is common.

Nitrates and nitrites are commonly used in curing materials. Nitrates and nitrites impart a bright red to pink color in the meat product. Additionally, nitrates and nitrites affect the flavor of the meat product. Nitrates and nitrites also have desirable characteristics for preserving the meat product. Nitrates and nitrites may act as antioxidants in the meat product. Antioxidants may help prevent the development of oxidative rancidity. Furthermore, nitrates and nitrites may assist in preventing the growth of food poisoning microorganisms such as Clostridium botulimum. Examples of nitrates and nitrites that may be used in curing materials include but are not limited to potassium nitrate, potassium nitrite, sodium nitrate and sodium nitrite.

Nitrates and nitrites are toxic in large amounts and must be used with caution when included as an ingredient of a curing material. Federal and state regulations limit the amount of nitrates and nitrites that can be used in curing. The use of sodium nitrate or potassium nitrate (saltpepper) is 3.5 ounces per 100 pounds of meat for dry cure or 7 pounds of nitrate per 100 gallons of liquid cure (pickle) at 10% pump level. The use of sodium nitrite or potassium nitrite is limited to 1 ounce per 100 pounds meat for dry cure or 2 pounds per 100 gallons liquid cure at 10% pump level.

Sugar is another common ingredient in curing materials. Sugar may add flavor to the meat product and the sugar may counteract the harshness of salt.

Ascorbates may be used in a curing material. Ascorbates may be used to speed the curing reaction through more rapid reduction of nitrates and nitrites into nitric oxide. Any curing accelerator known in the art may be used to accelerate curing. Two common curing accelerator compounds are sodium ascorbate and sodium erythorbate.

Phosphate is a common ingredient in liquid cure. Phosphates are adjuncts used to increase water holding capacity of cured products. Increased water holding capacity will increase product yields and improve brine retention. Sodium tripolyphosphate, sodium hexametaphosphate and sodium pyrophosphate are approved by the United State Department of Agriculture for use in meat curing.

Water is frequently used as an ingredient of liquid cures. Water may serve many functions in a liquid cure, including: acting as a carrier of other ingredients, influencing composition of the meat, and contributing to the palatability or juiciness of the product. Yield of the finished meat product may be dependent upon the amount of water retained during the curing and cooking process.

Curing materials may be in either dry or liquid form and they may be applied either to the surface of the meat product or into the meat product by some injection method. Dry cure material may be applied by rubbing the cure material onto the surface of the meat product. When curing meat products the meat product may be held in a non-corrosive vat or container that will drain so the cuts do not rest in their own brine. If dry cure mix is dissolved in water it is called a brine or pickle. The meat product maybe covered with the pickle. The system of covering the meat product with the pickle is known as immersion curing. Immersion curing may be slower than using dry cure material and the pickle solution may need to be changed during the curing process to prevent spoilage. Curing and seasoning material may also be applied using a tumbling method. Tumbling is a method of applying seasoning and cure to meat. Tumbling applies the seasoning and cure material to the meat product by placing the meat and the cure and seasoning material in a rotating drum. The drum is rotated which may allow the seasoning and cure material to cover the meat product. The seasoning and cure material may be applied using a vacuum tumbler. Tumbling the meat product in a vacuum opens the cell structure of the meat product and may allow the seasoning and cure material to distribute evenly over the product.

A curing material may contain any ingredients in any proportions known in the art to cure meat. A recipe for a curing material may include 8 pounds of salt, 3 pounds of sugar, 2 ounces sodium nitrate, ½ ounce sodium nitrite. The curing material may be applied to the outside of the meat product. One ounce of the curing material may be applied to one pound of the meat product. Another recipe for a curing material may include curing material that is 52% water, 27% seasoning blend, 20% sugar, and 1% cure. An alternative seasoning and cure material may include 49% water, 30% seasoning blend, 20% sugar, and 1% cure. An alternative recipe may include 42% water, 33% seasoning blend, 25% sugar, and 1% cure. However, the curing material may be applied in any amount that will provide desirable curing characteristics.

The cure material may be injected into the meat. The cure material may be injected may be injected directly into the muscle. The cure material may also be injected into the arterial system. Injecting the cure material into the arterial system utilizes the naturally occurring vascular network for quicker and complete distribution of the cure. Injecting the cure material into the arterial system may reduce the time necessary to cure the meat.

The length of the curing process is dependent upon a number of factors, including but not limited to the size of the meat, the type of meat used, the type of cure used. The length of the cure may be seven days per inch of thickness of the meat. However, the length of the cure time may be varied to yield a meat product that is preserved and has desirable flavor characteristics.

The meat product may be smoked. Smoked meat is less likely to spoil than meat which has not been smoked. Smoking improves the flavor and appearance of the meat, aids in reducing mold growth, and may retard rancid flavors. The wood used to generate the smoke should be of the hardwood species. For example wood or sawdust from hickory, apple, plum, oak, maple, ash or any non-resinous woods may be used to smoke the meat product. Smoke may be generate from a hardwood smoke generator using woods chips, or sawdust. Liquid smoke may also be used to smoke the meat product. Liquid smoke may be produced by burning hardwood ships and then condensing the smoke particles with water into a liquid smoke. The liquid smoke may then be applied to the meat product by atomizing the liquid smoke. Smoke may be applied during the cooking process such as within a zone of a continuous oven or as a step in a bath oven cycle. When smoking the meat product the meat product is cooked until the meat reaches a target moisture level. The meat product may be smoked for a time ranging from 90-300 minutes. However, the length of time to smoke and cook meat may vary depending on properties of the meat.

The seasoning and cure solution may include any ingredients and flavors necessary to give a desirable flavor. The seasoning and cure solution may include any or all of the ingredients, including sodium nitrate, water, salt, sugar, spices and flavors. The meat product 1 may be cured for any length of time necessary to give the meat product 1 the desired flavor. The meat product 1 may be cured between 12 hours and 60 hours.

The meat product 1 may be cooked for any length of time necessary to prepare the meat product for consumption. For example the meat product 1 may be cooked for a length of time between 90 and 210 minutes. The meat product 1 may be cooked by any method known in the art. For example, the meat product 1 may be grilled, broiled or roasted.

The meat product 1 depicted in FIG. 1 may be made from beef. Alternatively, the meat product 1 may be made from any type of meat coming from any suitable species. The meat product 1 may be made from turkey, chicken, venison, elk, salmon, tuna, pork, or other forms of wild game.

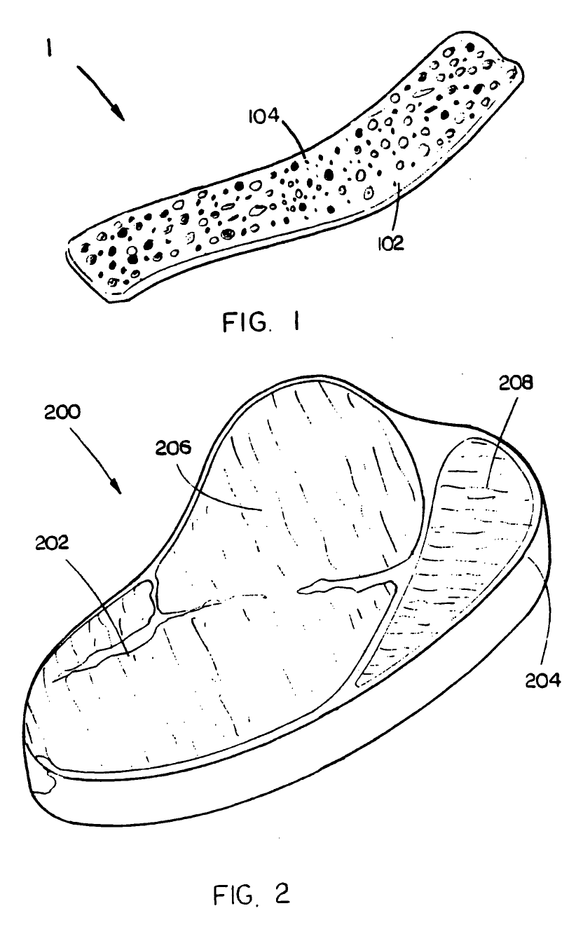

Referring now to FIG. 2, the meat product 1 may be made from a whole muscle cut of meat 200. The whole muscle cut of meat 200 depicted in FIG. 2 may be a center-cut beef sirloin. The center-sirloin depicted has two muscles, the larger muscle 202 and the smaller muscle 204 sometimes called the “mouse muscle”. The larger muscle 202 has muscle fibers 206 oriented in a substantially uniform direction, the smaller muscle 204 also has muscle fibers 208 oriented in a substantially uniform direction. The orientation of the muscle fibers of the larger muscle 204 is different than the orientation of the muscle fibers of the smaller muscle 208. The smaller muscle 206 may be removed from the center-cut sirloin, allowing the Larger muscle 204 to be oriented to the cutting device in a direction which allows the larger muscle 202 to be cut substantially across the grain of the muscle fibers 206. It should be noted that the terms cut and slice are used synonymously.

The whole muscle cut of meat 202 depicted in FIG. 2 may be a center-cut beef sirloin. Alternatively, the whole muscle cut of meat 202 may be from any animal species having desirable characteristics. The whole muscle cut of meat may be selected from an animal other than beef, including turkey, chicken, venison, elk, salmon, tuna, pork, or other forms of wild game. Alternatively, the whole muscle cut of meat 202 may be a cut of meat other than a center-cut sirloin. The whole muscle cut of meat 202 may be from rounds, loins, or center-cut sirloins.

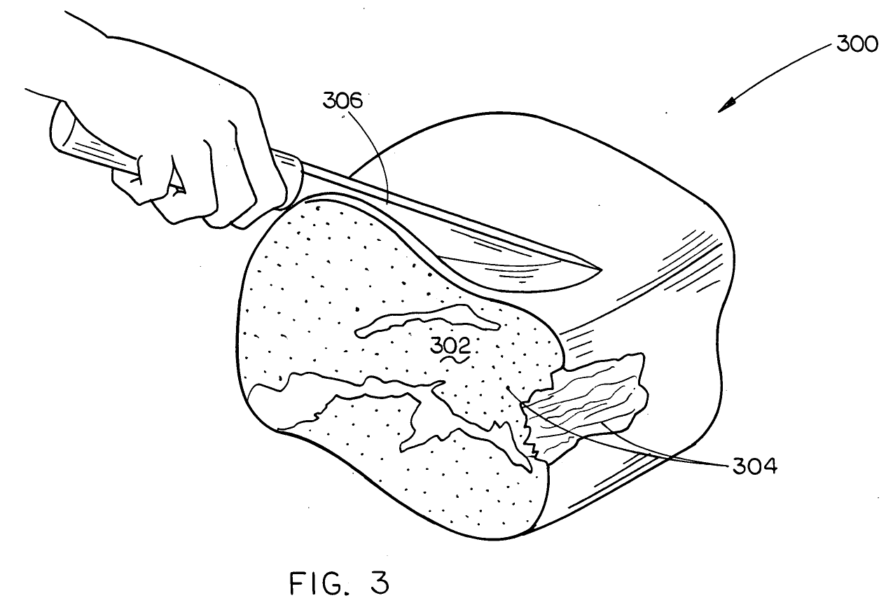

Referring now to FIG. 3, a cut of meat 300 is depicted. The cut of meat 300 has fibers oriented in a substantially uniform direction 304 and is being cut by a knife 306, yielding portions of meat 302. The knife is oriented to cut the meat substantially across the grain of the muscle fibers 304.

The cut of meat 300 may be cut substantially across the grain of the muscle fibers 304. Cutting the cut of meat 300 substantially across the grain of the muscle fibers 304 may yields a meat product 1 which is more tender than a meat product sliced substantially with the grain of the muscle fibers. Meat products sliced in a substantially with the grain of the muscle fibers have long strands of muscle fibers which may be difficult to chew. The meat product 1 is sliced substantially across the grain of the muscle fibers yielding a meat product with small strands of muscle fibers which may be easier to chew, resulting in a more tender meat product. As such, it may be desirable to cut a cut of meat 300 with a high content of collagen and elastin substantially across the grain of the muscle fibers to yield a more tender meat product 1. The phrase “across the grain” is contemplated to include cutting the meat substantially perpendicular to the orientation of the muscle fibers of the cut of meat. The phrase “with the grain” is contemplated to include cutting the meat substantially parallel to orientation of the muscle fibers of the cut of meat.

The cut of meat 300 may be sliced or cut using a knife. Alternatively, the cut of meat 300 may be sliced or cut using any method known in the art. The cut of meat 300 may be cut using band saws and circular blades.

The cut of meat 300 may come from any animal suitable for consumption. The cut of meat 300 may come from turkey, chicken, venison, elk, salmon, tuna, pork, or other forms of wild game.

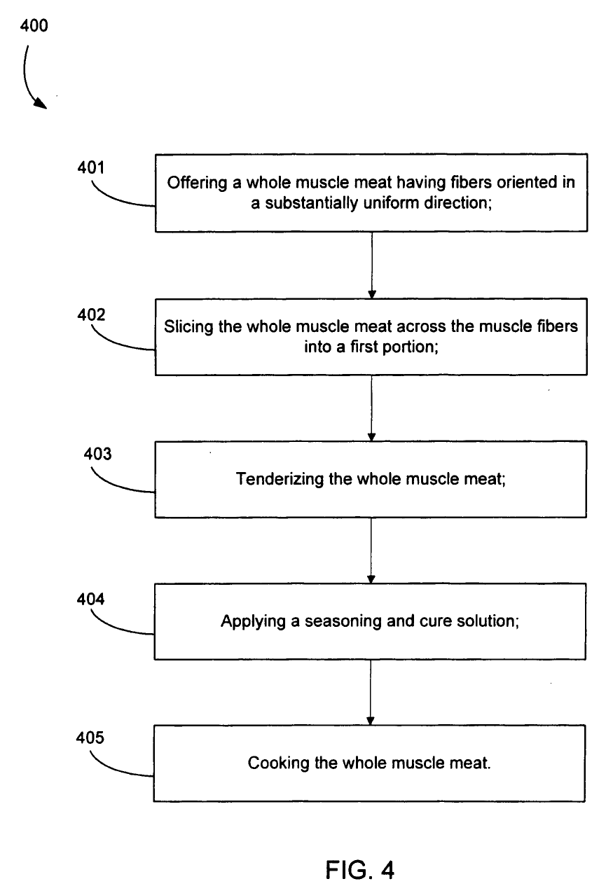

Referring now to FIG. 4, a flow chart depicting the method 400 for making a meat product is depicted, including offering a cut of meat which is approximately 100% visual lean having fibers oriented in a substantially uniform direction 402, slicing the cut of meat substantially across the grain of the muscle fibers into a first portion 404, tenderizing the cut of meat 406, applying a seasoning and cure solution to the cut of meat 408, and cooking the cut of meat 412.

The step of offering a cut of meat 402 may include offering any cut of meat from any species suitable for making the meat product 1. The cut of meat may come from beef, turkey, chicken, venison, elk, salmon, tuna, pork, or other forms of wild game. The cut of meat used may come from any cut of meat suitable for making the meat product 1, including rounds, loins, or center-cut sirloins.

The step of slicing the cut of meat substantially across the grain of the muscle fibers 404, may be accomplished using any method known in the art to cut meat. The cut of meat may be sliced using a knife, band saw or circular blade.

The step of tenderizing the cut of meat 406 may be accomplished using blade hammers or blade tenderizers or a combination of both blade hammers and blade tenderizers.

The seasoning and cure solution may be applied to the meat 408 using any method known in the art to apply seasoning and cure solutions. The seasoning and cure solution may be injected or applied to the outside of the cut of meat, or a combination of both injecting and applying to the outside of the meat may be used. The seasoning and cure solution applied to the meat may include a blend sodium nitrate, water, salt, sugar, spices and other flavors.

The step of cooking the cut of meat 412 may be accomplished using any method known in the art to cook meat, for example roasting, grilling or broiling After cooking the cut of meat, the meat may be seasoned using sodium nitrate, water, salt, sugar, spices and flavors. The cooked meat may be cooked to meet the requirements of a kippered meat product or a jerky meat product.

It is believed that the present application and many of its attendant advantages will be understood by the foregoing description, and it wilt be apparent that various changes may be made in the form, construction and arrangement of the components thereof without departing from the scope and spirit of the application or without sacrificing all of its material advantages. The form herein before described being merely an explanatory embodiment thereof, it is the intention of the following claims to encompass and include such changes.

What is claimed is:

1. A meat product, comprising:
a cut of meat having muscle fibers oriented in a substantially uniform direction; and
wherein the cut of meat is cut across the grain of the muscle fibers.

2. A meat product, comprising:
a cut of meat having muscle fibers oriented in a substantially uniform direction; and
a seasoning and cure solution,
wherein the cut of meat is cut across the grain of the muscle fibers, and
wherein the seasoning and cure solution is applied to cut of meat.

3. The meat product of claim 2, wherein the seasoning and cure solution is applied using at least one method of application selected from the group consisting of topical application, injection, immersion and tumbling.

4. The meat product of claim 2, wherein the cut of meat is selected from the group consisting of: beef, turkey, chicken, venison, elk, salmon, tuna, pork, and wild game.

5. The meat product of claim 2, wherein the cut of meat is at least one selected from the group consisting of: rounds and center cut sirloins.

6. The meat product of claim 2, wherein the cut of meat is tenderized using at least one selected from the group consisting of: a blade tenderizer and a blade hammer.

7. The meat product of claim 2, wherein the meat is cured for a length of time between 12 hours and 90 hours.

8. The meat product of claim 2, wherein the meat product is cooked for a length of time between 90 minutes and 210 minutes.

9. The meat product of claim 2, wherein the meat has a moisture content between 41% and 45% by mass of the meat.

10. The meat product of claim 2, wherein the seasoning and cure solution contains a least one from the group consisting of: sodium nitrate, water, salt, sugar, spice, and flavors.

11. The meat product of claim 2, wherein the meat product has a fat content of less than 16.0% by mass of the meat product.

12. The meat product of claim 2, wherein the meat product has a protein content of at least 28.2% by mass of the meat product.

13. The meat product of claim 2, wherein the meat product has a salt content of less than least 6.7% by mass of the meat product.

14. The meat product of claim 2, wherein the meat product has an aerobic plate count of less than 150,000 colonies per gram of meat product.

15. The meat product of claim 2, wherein the meat product has a water activity less than or equal to 0.85.

16. The meat product of claim 2, wherein the meat product is preserved using a least one technique selected from the group consisting of kippering and jerkying.

17. A method for making a meat product, comprising the steps of
offering a cut of meat having fibers oriented in a substantially uniform direction;
slicing the cut of meat across the muscle fibers into a first portion;
tenderizing the meat;
applying a seasoning and cure solution to the meat; and
cooking the meat.

18. The method for making the meat product of claim 16, further comprising the step of:
preserving the meat product.

19. The method for making the meat product of claim 17, wherein the step of preserving the meat product further comprises the step of at least one of jerkying and kippering.

20. The method for making the meat product of claim 16, wherein the seasoning and cure solution is applied using at Least one method of application selected from the group consisting of topical application, injection, and immersion.

21. The method for making the meat product of claim 16, wherein the cut of meat is selected from the group consisting of: beef, turkey, chicken, venison, elk, salmon, tuna, pork, and wild game.

22. The method for making the meat product of claim 16, wherein the cut of meat is at least one selected from the group consisting of:
rounds and center cut sirloins.

23. The method for making the meat product of claim 16, wherein the cut of meat is tenderized using at least one selected from the group consisting of: a blade tenderizer and a blade hammer.

24. The method for making the meat product of claim 16, wherein the meat is cured for a length of time between 12 hours and 60 hours.

25. The method for making the meat product of claim 16, wherein the meat product is cooked for a length of time between 90 minutes and 210 minutes.

26. The method for making the meat product of claim 16, wherein the meat is cooked until the meat product has a moisture content of 41% and 45% by mass of the meat product.

27. The method for making the meat product of claim 16, wherein the seasoning and cure solution contains a least one from the group consisting of: sodium nitrate, water, salt, sugar, spice, and flavors.
